(19) United States
(12) Patent Application Publication
(10) Pub. No.: US 2012/0174952 A1
(43) Pub. Date: Jul. 12, 2012

(54) Mask Cleaning Apparatus

(75) Inventor: Taek-Kyo Kang, Yongin-City (KR)

(73) Assignee: SAMSUNG MOBILE DISPLAY CO., LTD., Yongin-City (KR)

(21) Appl. No.: 13/238,977

(22) Filed: Sep. 21, 2011

(30) Foreign Application Priority Data
Jan. 11, 2011 (KR) 10-2011-0002880

(51) Int. Cl. B08B 3/12

(52) U.S. Cl. 134/147

(57) ABSTRACT

A mask cleaning apparatus comprises: a bath containing a cleaning liquid; an ultrasonic wave generation unit for generating and applying ultrasonic waves to the cleaning liquid; a supporting member for supporting the mask; and a driving unit formed to rotate the mask in the bath. As a result, the mask cleaning apparatus achieves an improved mask cleaning capability.

### CLAIM OF PRIORITY

This application makes reference to, incorporates the same herein, and claims all benefits accruing under 35 U.S.C. §119 from an application earlier filed in the Korean Intellectual Property Office on the 11^{th} of Jan. 2011 and there duly assigned Serial No. 10-2011-0002880.

### BACKGROUND OF THE INVENTION

1. Field of the Invention

The present invention relates to a mask cleaning apparatus, and more particularly, to a mask cleaning apparatus having an improved mask cleaning capability.

2. Description of the Related Art

Currently, display apparatuses are being replaced by portable thin flat panel display apparatuses. Among flat panel display apparatuses, organic light-emitting display apparatuses are self-emissive display apparatuses and are regarded as next-generation display apparatuses due to their wide viewing angles, excellent contrast characteristics, and high response speeds.

An organic light-emitting display apparatus includes an intermediate layer, a first electrode, and a second electrode. The intermediate layer includes an organic emission layer which generates visible light when a voltage is applied to the first and second electrodes.

Various methods are used to form the intermediate layer including the organic emission layer in a desired pattern, and one of them is a deposition method using a mask. In more detail, a mask having openings in a desired pattern is disposed between a deposition source and a substrate on which an intermediate layer is to be formed, and then a deposition process may be performed to form the intermediate layer.

In a deposition process, a deposition material such as an organic material may be adhered near openings of a mask, and thus the deposition process may not form a desired pattern. In order to solve this problem, a mask is cleaned after the deposition process is performed.

However, due to difficulties of a mask cleaning process, improvement in the mask cleaning capability bas been needed.

### SUMMARY OF THE INVENTION

The present invention provides a mask cleaning apparatus having an improved mask cleaning capability.

According to the present invention, a mask cleaning apparatus comprises: a bath containing a cleaning liquid; an ultrasonic wave generation unit for generating and applying ultrasonic waves to the cleaning liquid; a supporting member for supporting the mask; and a driving unit formed to rotate the mask in the bath.

The mask may include a plurality of openings, and the mask may be supported by the supporting member in such a way that a surface in which the openings are formed is parallel to a direction of gravity.

The ultrasonic wave generation unit may be disposed adjacent to a bottom of the bath.

The ultrasonic wave generation unit may be disposed in the bath.

The mask may be fixed to the supporting member, the driving unit may rotate the supporting member, and the mask may rotate due to the rotation of the supporting member.

The driving unit may be disposed on the supporting member.

The driving unit may be connected to a motor.

The mask may include a plurality of openings, and the mask may rotate about a straight line perpendicular to a surface in which the openings are formed.

The mask may include a plurality of openings, and the mask may rotate about a straight line parallel with a surface in which the openings are formed, and perpendicular to a direction of gravity.

The mask may be cleaned while continuously rotating in the bath and contacting the cleaning liquid.

The mask may rotate by at least 360° in one direction in the bath.

The mask may rotate in the bath by a predetermined angle in one direction, and then rotate by the predetermined angle in an opposite direction.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a perspective view of a mask cleaning apparatus according to an embodiment of the present invention;

FIG. 2 is a side view of the mask cleaning apparatus illustrated in FIG. 1;

FIG. 3 is an exploded perspective view of a mask illustrated in FIG. 1;

FIG. 4 is a front view showing operation of the mask cleaning apparatus illustrated in FIG. 1;

FIG. 5 is a perspective view of a mask cleaning apparatus according to another embodiment of the present invention; and

FIG. 6 is a side view showing operation of the mask cleaning apparatus illustrated in FIG. 5.

### DETAILED DESCRIPTION OF THE INVENTION

Hereinafter, the present invention will be described in detail by explaining embodiments of the invention with reference to the attached drawings.

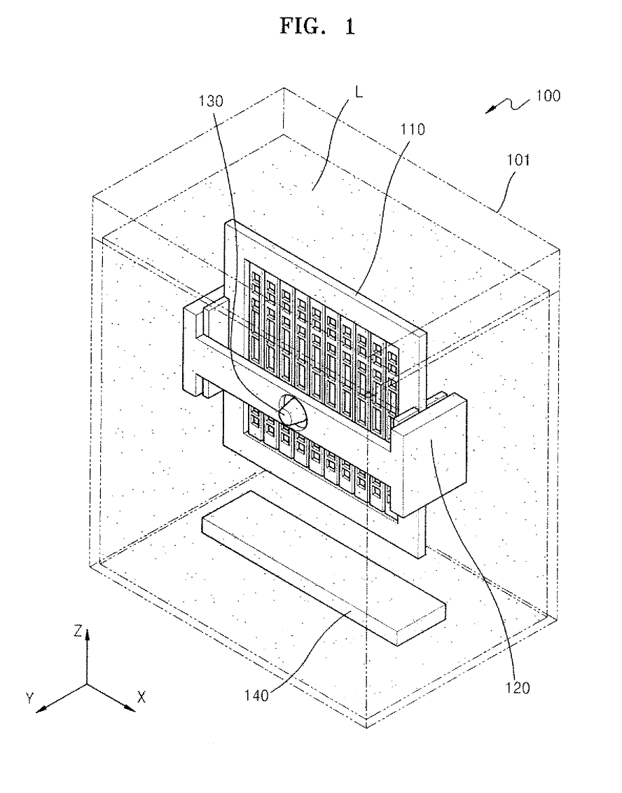

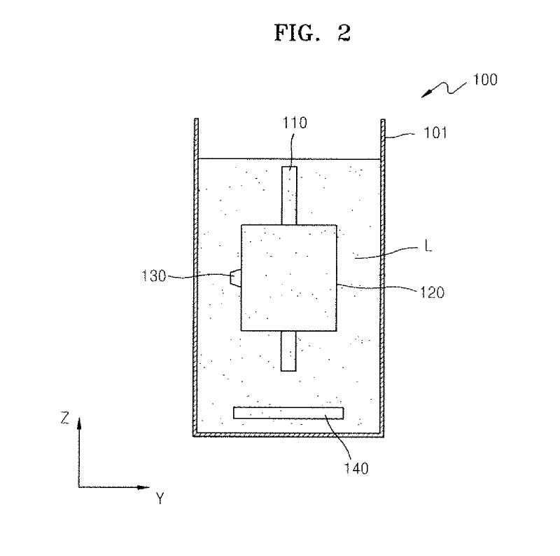

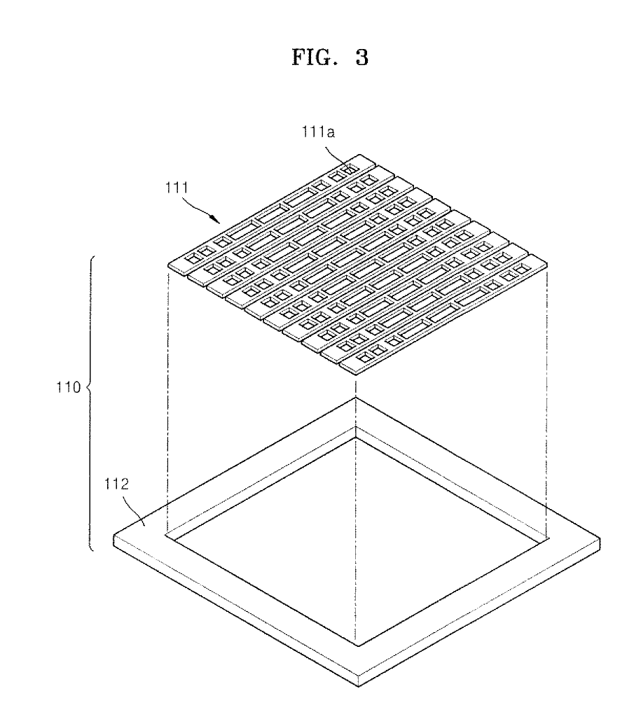

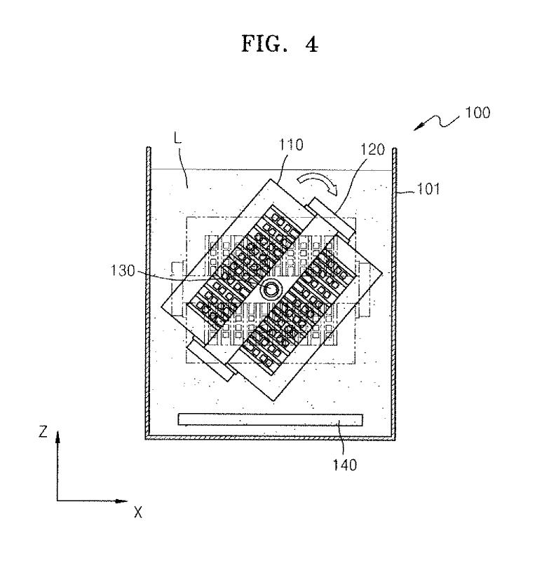

FIG. 1 is a perspective view of a mask cleaning apparatus according to an embodiment of the present invention; FIG. 2 is a side view of the mask cleaning apparatus illustrated in FIG. 1; FIG. 3 is an exploded perspective view of a mask illustrated in FIG. 1; and FIG. 4 is a front view showing operation of the mask cleaning apparatus illustrated in FIG. 1.

Referring to FIGS. 1 thru 3, the mask cleaning apparatus 100 comprises a bath 101, a supporting member 120, an ultrasonic wave generation unit 140, and a driving unit 130.

Each element will now be described in detail.

The bath 101 contains a cleaning liquid L. The cleaning liquid L may contain acid to remove, for example, an organic material remaining on the mask 110. However, the current embodiment is not limited thereto, and the cleaning liquid L may be of various types.

The bath 101 has a size sufficient for the whole mask 110 to be fully submerged therein.

The supporting member 120 supports the mask 110. Specifically, the supporting member 120 supports the mask 110 in such a way that the mask 110 is vertically disposed in the bath 101. That is, the supporting member 120 supports the mask 110 in the bath 101 in such a way that a wide surface of the mask 110 is parallel with a direction of gravity.

Also, the supporting member 120 is formed so as to continuously and safely fix the mask 110 when the mask 110 rotates and is cleaned in the bath 101. The supporting member 120 is spaced apart from the bath 101.

As illustrated in FIG. 3, the mask 110 includes a main body 111 and a frame 112. The main body 111 is formed by using a thin metal film. Although the main body 111 is split into a plurality of pieces in FIG. 3, the current embodiment is not limited thereto, and the main body 111 may be formed integrally. The main body 111 includes openings 111a in a predetermined pattern. The main body 111 is fixed to the frame 112.

A deposition process is performed by using the mask 110 to form an organic material layer, e.g., an organic emission layer, of an organic light-emitting display apparatus. In particular, a deposition material is deposited on a substrate through the openings 111a. After the deposition process, contaminants may be formed in and around the openings 111a.

The ultrasonic wave generation unit 140 generates and applies ultrasonic waves to the cleaning liquid L contained in the bath 101. The ultrasonic wave generation unit 140 may be disposed in the bath 101, for example, on a lower surface of the bath 101.

The ultrasonic wave generation unit 140 generates ultrasonic waves to effectively remove contaminants adhering to the mask 110 while the mask 110 is being cleaned in the bath 101.

The driving unit 130 is disposed on the supporting member 120, for example, on a surface of the supporting member 120 facing the openings 111a of the mask 110. The driving unit 130 is formed so as to rotate the mask 110 fixed to the supporting member 120. In more detail, the driving unit 130 rotates the supporting member 120, and the mask 110 fixed to the supporting member 120 rotates due to the rotation of the supporting member 120.

The driving unit 130 is connected to a motor (not shown) so as to rotate the mask 110. The motor may be disposed in the bath 101, for example, on an inner wall of the bath 101. However, the current embodiment is not limited thereto, and the motor maybe disposed outside the bath 101, for example, on an upper surface of the bath 101.

Operation of the mask cleaning apparatus 100 will now be schematically described with reference to FIG. 4.

The mask 110 used to perform the deposition process at least once is put into the bath 101 containing the cleaning liquid L. In this case, the mask 110 is fixed to the supporting member 120. Then, the ultrasonic wave generation unit 140 generates ultrasonic waves to clean the mask 110. As such, contaminants adhering to the mask 110 may be effectively removed.

Also, the driving unit 130 rotates while the mask 110 is being cleaned. Specifically, the driving unit 130 rotates the supporting member 120, and thus the mask 110 fixed to the supporting member 120 rotates while being cleaned. In more detail, the mask 110 rotates about a straight line perpendicular to a surface in which the openings 111a are formed (a Y axis direction in FIG. 1). That is, the mask 110 rotates on the same plane as the surface in which the openings 111a are formed.

The driving unit 130 may perform various rotary motions. For example, the driving unit 130 may perform at least one full rotation, i.e., 360°, in one direction (e.g., a direction indicated by a clockwise arrow in FIG. 4). Also, the driving unit 130 may repeat the above rotary motion.

Alternatively, the driving unit 130 may perform a half rotation, i.e., 180°, in a clockwise direction, and then may perform another half rotation in a counterclockwise direction. Also, the driving unit 130 may repeat the above rotary motion.

However, the current embodiment is not limited thereto, and the driving unit 130 may rotate by a predetermined angle, e.g., 90°, in a clockwise direction, and then may rotate by the predetermined angle in a counterclockwise direction. Also, the driving unit 130 may repeat the above rotary motion.

Due to the rotation of the mask 110, a portion of the mask 110 adjacent to a bottom of the bath 101 moves toward a top of the bath 101, and a portion of the mask 110 adjacent to the top of the bath 101 moves toward the bottom of the bath 101. Accordingly, the position of a certain portion of the mask 110 continuously changes.

As such, the capability of cleaning the mask 110 is improved. In more detail, since the mask 110 is vertically disposed in the bath 101, contaminants removed from the mask 110 while the mask 110 is being cleaned may, due to gravity, again adhere to the mask 110 at the portion of the mask 110 adjacent to the bottom of the bath 101, and thus the mask 110 may be contaminated again. However, in the current embodiment, since the mask 110 rotates, re-contamination on a certain portion of the mask 110 is prevented, and thus the whole mask 110 may be easily cleaned.

Also, since the cleaning process is performed while the mask 110 continuously rotates in the cleaning liquid L contained in the bath 101, the cleaning capability is improved.

Meanwhile, a portion of the mask 110 adjacent to the ultrasonic wave generation unit 140 may be physically deformed due to ultrasonic waves generated by the ultrasonic wave generation unit 140 while the mask 110 is being cleaned. However, in the current embodiment, deformation of a certain portion of the mask 110 due to ultrasonic waves is easily prevented by rotating the mask 110.

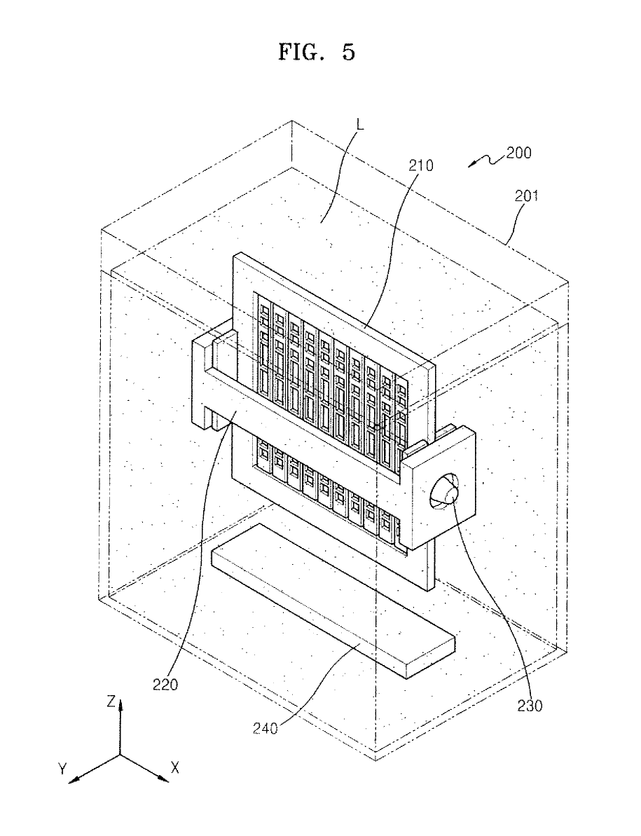

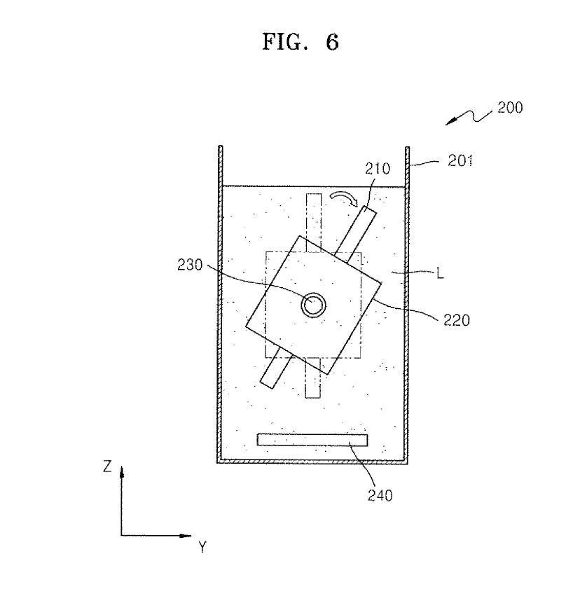

FIG. 5 is a perspective view of a mask cleaning apparatus according to another embodiment of the present invention; and FIG. 6 is a side view showing operation of the mask cleaning apparatus illustrated in FIG. 5.

Referring to FIGS. 5 and 6, the mask cleaning apparatus 200 comprises a bath 201, a supporting member 220, an ultrasonic wave generation unit 240, and a driving unit 230.

Each element will now be described in detail.

The bath 201 contains a cleaning liquid L. The cleaning liquid L may be of various types for removing, for example, an organic material remaining on the mask 210.

The bath 201 has a size sufficient for the whole mask 210 to be submerged therein, and for the mask 210 to rotate in the bath 201 as illustrated in FIG. 6.

The supporting member 220 supports the mask 210. Specifically, the supporting member 220 supports the mask 210 in such a way that the mask 210 is vertically disposed in the bath 201. That is, the supporting member 220 supports the mask 210 in the bath 201 in such a way that a wide surface of the mask 210 is parallel to a direction of gravity.

Also, the supporting member 220 is formed so as to continuously and safely fix the mask 210 when the mask 210 rotates and is cleaned in the bath 201. The supporting member 220 is spaced apart from the bath 201.

The configuration of the mask 210 is the same as that of the mask 110 illustrated in FIG. 3, and thus a detailed description thereof will not be provided here.

The ultrasonic wave generation unit 240 generates and applies ultrasonic waves to the cleaning liquid L contained in the bath 201. The ultrasonic wave generation unit 240 may be disposed in the bath 201, for example, on a lower surface of the bath 201.

The ultrasonic wave generation unit 240 generates ultrasonic waves so as to effectively remove contaminants adhered to the mask 210, while the mask 210 is being cleaned in the bath 201.

The driving unit 230 is disposed on the supporting member 220, for example, on a surface of the supporting member 220 perpendicular to a surface facing openings of the mask 210. That is, the driving unit 230 is formed on a surface of the supporting member 220 facing a side surface of the mask 210.

The driving unit 230 is formed so as to rotate the mask 210 fixed to the supporting member 220. In more detail, the driving unit 230 rotates the supporting member 220, and the mask 210 fixed to the supporting member 220 rotates due to the rotation of the supporting member 220.

The driving unit 230 is connected to a motor (not shown) so as to rotate the mask 210. The motor may be disposed in the bath 201, for example, on an inner wall of the bath 201. However, the current embodiment is not limited thereto, and the motor may be disposed outside the bath 201, for example, on an upper surface of the bath 201.

Operation of the mask cleaning apparatus 200 will now be schematically described.

The mask 210 used to perform the deposition process at least once is put into the bath 201 containing the cleaning liquid L. In this case, the mask 210 is fixed to the supporting member 220. Then, the ultrasonic wave generation unit 240 generates ultrasonic waves to clean the mask 210. As such, contaminants adhering to the mask 210 are effectively removed.

Also, the driving unit 230 rotates while the mask 210 is being cleaned. That is, the driving unit 230 rotates the supporting member 220, and thus the mask 210 fixed to the supporting member 220 rotates while being cleaned. In more detail, the mask 210 rotates about a straight line parallel to a surface in which the openings are formed, and perpendicular to a direction of gravity (an X axis direction in FIG. 5).

Due to the rotation of the mask 210, a portion of the mask 210 adjacent to a bottom of the bath 201 moves toward a top of the bath 201, and a portion of the mask 210 adjacent to the top of the bath 201 moves toward the bottom of the bath 201. Accordingly, the position of a certain portion of the mask 210 continuously changes.

As such, the capability of cleaning the mask 210 is improved. In more detail, contaminants removed from the mask 210 while the mask 210 is being cleaned may be prevented from adhering to the mask 210 again at the portion of the mask 210 adjacent to the bottom of the bath 201 due to gravity, thereby preventing re-contamination on a certain portion of the mask 210, and thus the whole mask 210 may be easily cleaned.

Also, deformation of a portion of the mask 210 adjacent to the ultrasonic wave generation unit 240 due to ultrasonic waves generated by the ultrasonic wave generation unit 240 while the mask 210 is being cleaned may be easily prevented by rotating the mask 210.

The mask cleaning apparatus according to the present invention easily achieves an improved mask cleaning capability.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A mask cleaning apparatus, comprising:
a bath containing a cleaning liquid;
an ultrasonic wave generation unit for generating and applying ultrasonic waves to the cleaning liquid;
a supporting member for supporting a mask; and
a driving unit for rotating the mask in the bath.

2. The mask cleaning apparatus of claim 1, wherein the mask comprises a plurality of openings; and
wherein the mask is supported by the supporting member in such a way that a surface in which the openings are formed is parallel to a direction of gravity.

3. The mask cleaning apparatus of claim 1, wherein the ultrasonic wave generation unit is disposed adjacent to a bottom of the bath.

4. The mask cleaning apparatus of claim 1, wherein the ultrasonic wave generation unit is disposed in the bath.

5. The mask cleaning apparatus of claim 1, wherein the mask is fixed to the supporting member; and
wherein the driving unit rotates the supporting member, and the mask rotates due to the rotation of the supporting member.

6. The mask cleaning apparatus of claim 1, wherein the driving unit is disposed on the supporting member.

7. The mask cleaning apparatus of claim 1, wherein the driving unit is connected to a motor.

8. The mask cleaning apparatus of claim 1, wherein the mask comprises a plurality of openings; and
wherein the mask rotates about a straight line perpendicular to a surface in which the openings are formed.

9. The mask cleaning apparatus of claim 1, wherein the mask comprises a plurality of openings; and
wherein the mask rotates about a straight line parallel to a surface in which the openings are formed, and perpendicular to a direction of gravity.

10. The mask cleaning apparatus of claim 1, wherein the mask is cleaned while continuously rotating in the bath and contacting the cleaning liquid.

11. The mask cleaning apparatus of claim 1, wherein the mask rotates by at least 360° in one direction in the bath.

12. The mask cleaning apparatus of claim 1, the mask rotates in the bath by a predetermined angle in one direction, and then rotates by the predetermined angle in an opposite direction.
